(19) United States
(12) Patent Application Publication
(10) Pub. No.: US 2006/0169153 A1
(43) Pub. Date: Aug. 3, 2006

(54) Conveniently accessible coffee filter holder

(76) Inventor: Mervin W. Hurtgam, Amherst, NY (US)

Correspondence Address: WALLACE F. NEYERLIN, Esq., 726 Division Avenue, Niagara Falls, NY, 14305, US

(21) Appl. No.: 11/045,982

(22) Filed: Jan. 31, 2005

(51) Int. Cl. A47J 43/14

(52) U.S. Cl. 99/495

(57) ABSTRACT

In combination, a coffee filter holder and an attachment piece therefor one surface of said attachment piece being connected to the holder and the opposite surface of said attachment piece possessing means for being connected to the inside surface of a cupboard door. The use of this combination, particularly when connected to the inside surface of the cupboard containing the cups and in a position above the cups provides for a location of the filters that is efficient, space-saving and conveniently accessible.

### FIELD OF THE INVENTION

This invention relates to providing a convenience for anyone who brews coffee using electric coffee makers employing coffee filters.

### SUMMARY OF THE INVENTION

It is an object of this invention to provide an easily accessible place for storing coffee filters and coffee filter holders.

It is another object of this invention to design a holder for coffee filters that can be conveniently screwed or adhered to a cupboard door.

It is another object of this invention to preferably attach the filter holder on the door of the cupboard that contains the cups of the user and to attach it on the inside of the door so that when the door is closed, the filter holder goes in above the cups.

It is another object of this invention to provide a space for storing filters where they are out of the way, located in a cupboard where they are out of the way in a space not usually used (above the cups) (thus also saving space) and to a space where it is handy and easy to return the filters to the filter holder.

The invention will be better understood by reference to the drawings.

### BRIEF DESCRIPTION OF THE DRAWINGS

FIG. 1 is a back elevation view of a coffee filter (Type “A”) holder assembly of the invention.

FIG. 1a is a top view of the coffee filter (Type “A”) holder assembly of FIG. 1.

FIG. 2 illustrates the installation of the holder assembly of FIG. 1 onto the inner surface of a cupboard door.

The bottom illustration of FIG. 2 showing an end view of the attachment piece being screwed to the cupboard door; the center illustration showing the filter holder about to be slided into the space between the attachment piece and the cupboard door; and the top illustration showing a multiple of coffee filters about to be inserted into the coffee filter holder.

FIG. 3 is a back elevation view of an alternative coffee filter holder assembly to hold the Type A filters of FIG. 1.

FIG. 3a is a top view of the alternative coffee filter holder of FIG. 3.

FIG. 4 is a back elevation view of the coffee filter holder assembly of FIG. 1; FIG. 4a being a cross-sectional view and FIG. 4b being a side-sectional view. In FIG. 3 the numeral 6 depicts an opening in the coffee filter holder for an attachment piece that may be glued to the cupboard door. In FIG. 4, the attachment piece may be either glued to the cupboard door or attached thereto by other adhesive materials or by screws through screw holes 7.

FIG. 5 is a back elevation view of a coffee filter (Type “B”) holder assembly of the invention.

FIG. 5a is a top view of the coffee filter (Type “B”) holder assembly of FIG. 5.

FIG. 6 illustrates the installation of the holder assembly of FIG. 5 onto the inner surface of a cupboard door.

FIG. 7 is a back elevation view of a coffee filter (Type “B”) holder assembly of the invention.

FIG. 7a is a top view of the holder assembly of FIG. 7.

FIG. 8 is a back elevation view of the coffee filter holder assembly of FIG. 5.

FIG. 8a is a top view of the coffee filter (Type “B”) holder assembly of FIG. 5; and FIG. 8b is a side sectional view of said assembly.

### DETAILED DESCRIPTION OF THE DRAWINGS

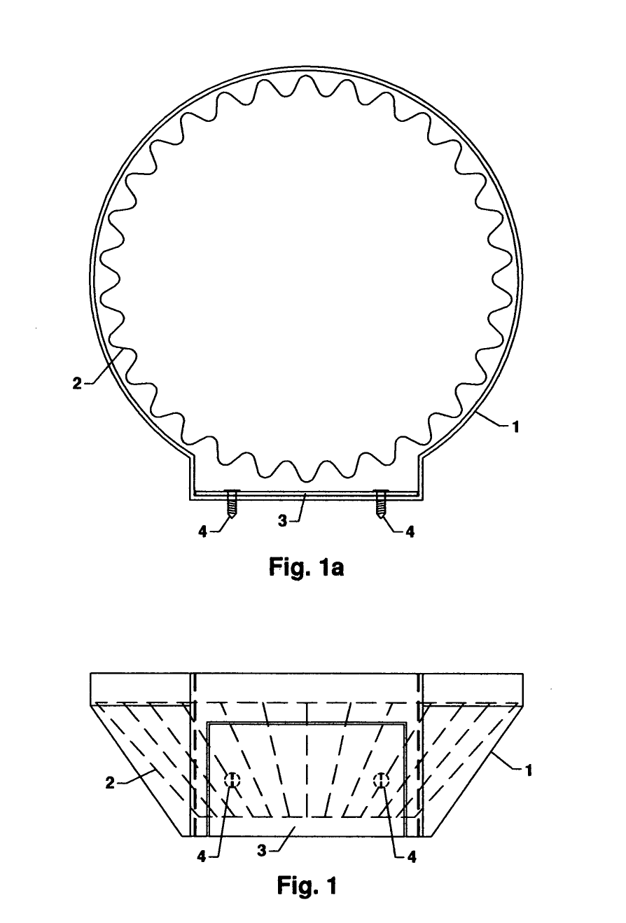

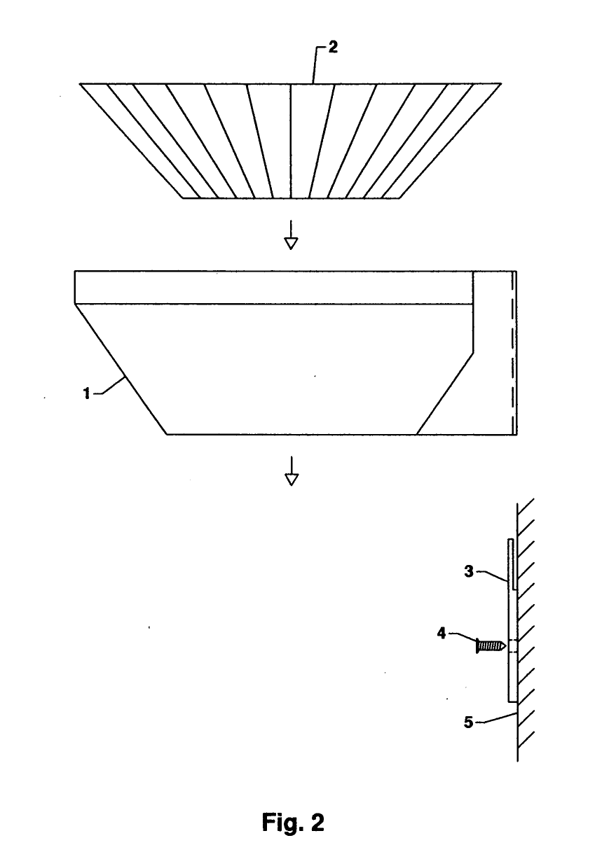

In FIGS. 1, 1a, 2, 3 and 3a, the numeral 1 designates the coffee filter holder for the Type “A” filters. Numeral 2 in FIGS. 1, 1a and 2 designates the Type “A” coffee filters. Numeral 3 in FIGS. 1, 1a 2, 4, 4a and 4b designates the attachment piece used in the installation of the coffee filter holder for the Type “A” coffee filters Numeral 4 in FIGS. 1, 1a, 2, 5, 5a and 6 designates screws which are used to connect the attachment pieces of the coffee filter holders for either the Type “A” or the Type “B” filter holders.

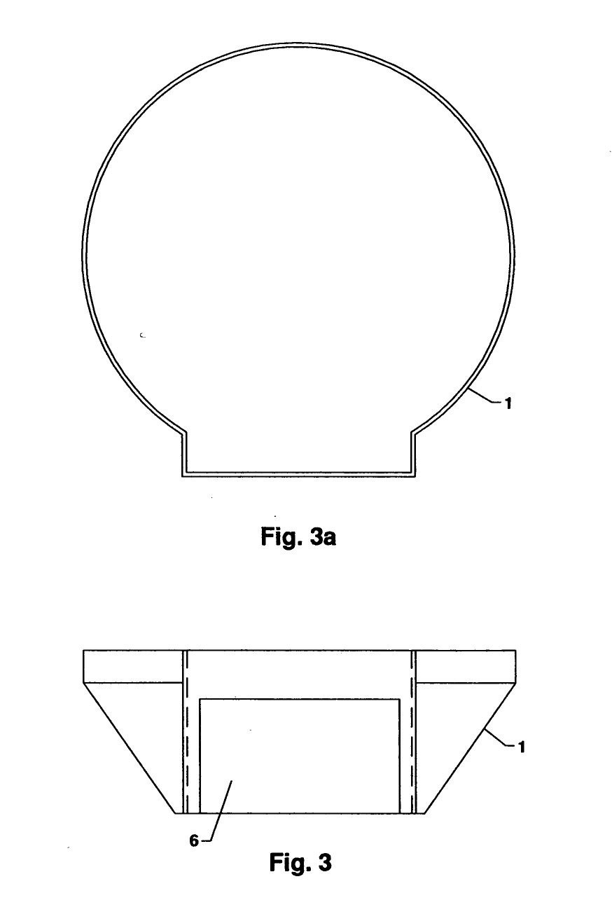

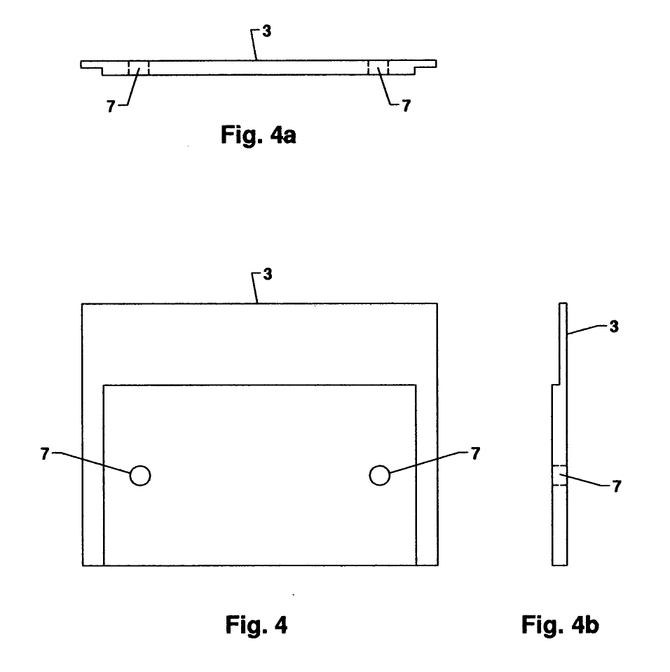

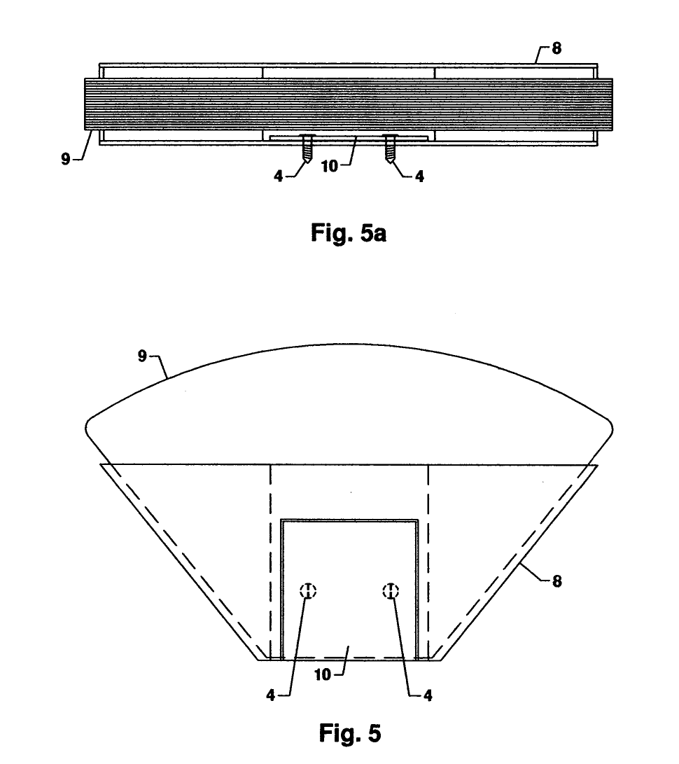

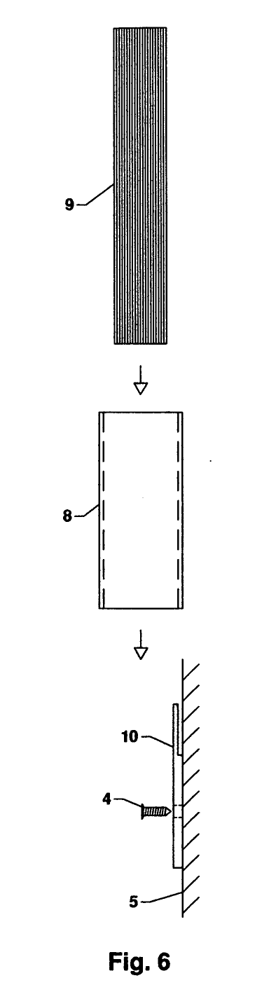

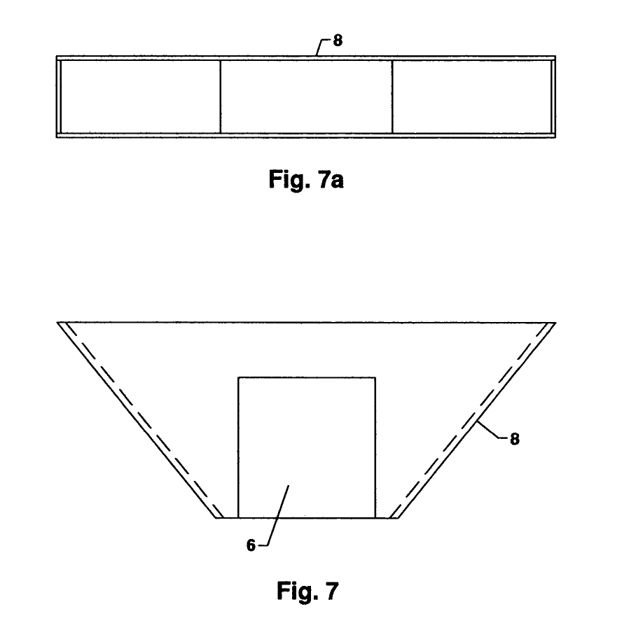

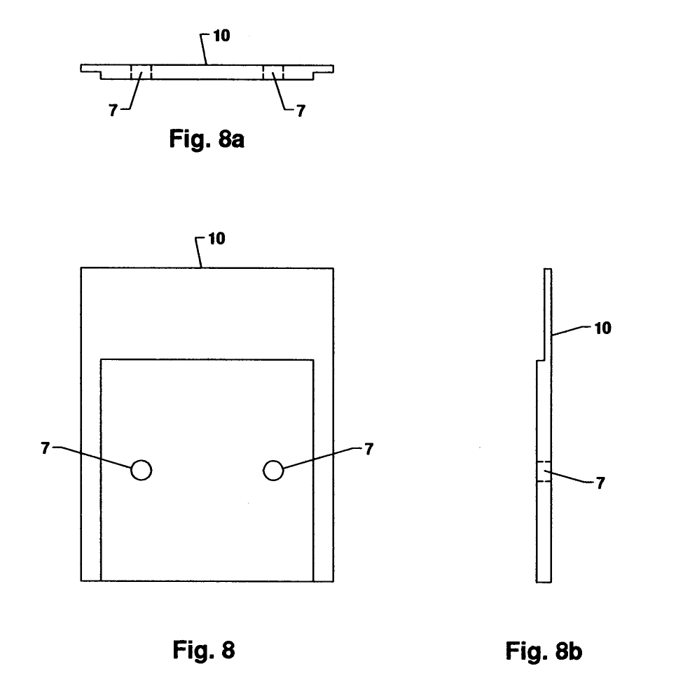

Numeral 5 in FIGS. 2 and 6 depicts the inside of the cupboard door to which either type of the filter holders is attached. Numeral 6 in FIGS. 3 and 7 depicts openings in either type of filter holder to accept the attachment pieces for either type holder. Numeral 7 in FIGS. 4, 4a, 4b and 8 8a and 8b depicts screw holes for the attachment pieces of either type of filter holder. Numeral 8 in FIGS. 5, 5a, 6, 7 and 7a depicts the coffee filter holder of the Type “B” filters. Numeral 9 in FIGS. 5a and 6 depicts the filters used in the Type B filter holders. These filters are singly removed from the multiple layers of filters shown in FIG. 5a and then spread out as a single filter as shown at the top of FIG. 5. FIG. 10 in FIGS. 5, 5a, 6 and 8, 8a and 8b depicts attachment pieces of the Type “B” filter holder

Coffee filter holders as shown in FIGS. 1 and 1a will typically be about 6 inches in diameter and about 2¼ inches deep. The holders illustrated in FIGS. 5 and 5a will typically be about 7½ inches long and about 3¼ inches deep. The width of the area showing the filters in FIG. 5a will typically be about 1 inch. Plastics or metals are generally the type of materials used to make the filter holders and the attachment pieces.

The forgoing description and embodiments are intended to illustrate the invention without limiting it thereby. It will be understood that various modifications can be made in the invention without departing from the spirit or scope thereof.

1. In combination, a coffee filter holder and an attachment piece there, one surface of said attachment piece being connected to the holder and the opposite surface of said attachment piece possessing means for being connected to the inside surface of a cupboard door, said holder and said attachment piece being readily separable from each other and also readily combined to each other.

2. A combination according to claim 1 wherein the means for connecting the attachment piece to the cupboard door consist of holes in the attachment piece and screws through the holes.

3. A combination according to claim 1 wherein the means for connecting the attachment piece to the cupboard door consists of a glue or other adhesive-like material.

4. A combination according to claim 1 wherein the coffee filter holder is cylindrically shaped.

5. A combination according to claim 1 wherein the coffee filter holder is rectangular in shape.

6. A combination according to claim 1 wherein the combination of the coffee filter holder and of the attachment piece are connected to the inside surface of the cupboard containing the cups and in a position above the cups.

7. A combination according to claim 4 wherein the top portion of the cylindrically shaped holder is about 6 inches in diameter.

8. A combination according to claim 5 wherein the rectangular shaped holder is about 7½ inches long and about 1 inch wide.
In the above amended claim 1, the period after door at the end of line 3 is crossed-off and the comma at the end is underlined
